(19) United States
(12) Patent Application Publication
(10) Pub. No.: US 2010/0065203 A1
(43) Pub. Date: Mar. 18, 2010

(54) SEALABLE WATER HEATER MANIFOLD DOORS

(76) Inventors: EMADEDDIN Y. TANBOUR, Johnson City, TN (US); Clifton A. Madden, Johnson City, TN (US)

Correspondence Address: MICHAEL BEST & FRIEDRICH LLP, 100 E WISCONSIN AVENUE, Suite 3300, MILWAUKEE, WI, 53202, US

(21) Appl. No.: 12/233,043

(22) Filed: Sep. 18, 2008

(51) Int. Cl. B29C 65/48

(52) U.S. Cl. 156/285; 156/325

(57) ABSTRACT

A sealable water heater manifold door is formed by adhering a gasket to a manifold door base plate. The manifold door base plate is sized and shaped to cover an opening in a water heater combustion chamber. The gasket is formed from a sealing material that is cut into multiple partial gaskets. The arrangement of multiple partial gaskets on the sealing material reduces excess and unusable sealing material. Each partial gasket has opposed ends that engage opposed ends of another partial gasket to form the gasket. A pair of partial gaskets is applied to an assembly device for accurate and quick placement of the pair of partial gaskets with the manifold door base plate. Door guides on the assembly device are used to align the base plate with the gasket, and the base plate is adhered to the gasket by an acrylic material that is applied to the gasket.

### TECHNICAL FIELD

This disclosure relates to manifold doors for water heaters. More particularly, the disclosure relates to sealable water heater manifold doors including a two part gasket.

### BACKGROUND

A combustion chamber of a water heater, such as a gas water heater, may include a removable assembly that is accessible through an open side portion of the combustion chamber. A plate or door is adapted to engage the open side portion of the combustion chamber. The door opens to allow access to the combustion chamber for, for example, removal or placement of the removable assembly. The door includes a sealing material adhered to the inner surface of the door to position against the outer surface of the combustion chamber for sealing the door to the combustion chamber. The sealing material may be a gasket with an opening sized essentially the same as the open side portion of the combustion chamber.

Current methods to form the gasket for the combustion chamber door inefficiently waste large portions of sealing material. Additionally, assembly of the gasket to the door is problematic as precisely and quickly aligning and adhering the gasket to the door is difficult. Thus, there is a need for forming the gaskets while minimizing the amount of wasted sealing material. There is a further need for a process to accurately and timely adhere the gasket to the door.

### SUMMARY

A sealable water heater manifold door for sealing and covering an opening in a water heater combustion chamber is formed with a manifold door base plate and a gasket. The manifold door base plate is sized and shaped to cover the opening. A sheet or strip of sealing material may be used to form the gasket. The sealing material may be cut to form multiple partial gaskets that each have opposed ends adapted to engage opposed ends of another partial gasket. A pair of partial gaskets may be applied to an assembly device in a position relative to guides of the assembly device. The partial gaskets may be engaged at their opposed ends to form the gasket. The manifold door base plate may be engaged with the guides for accurate placement of the manifold door base plate with respect to the gasket. The manifold door base plate may be adhered to the gasket to form the sealable water heater manifold door.

A gasket may be formed to be adhered to a manifold door base plate for forming a sealable water heater manifold door. A sheet or strip of sealing material may be provided. An outline of multiple partial gaskets may be formed on the sealing material. Each partial gasket may have opposed ends adapted to engage opposed ends of another partial gasket. The partial gaskets may be arranged on the sealing material to reduce excess and unusable sealing material. The sealing material may be cut along the outlines to form the partial gaskets, each of which may be engaged with another partial gasket at their opposed ends to form the gasket.

### BRIEF DESCRIPTION OF THE DRAWINGS

FIG. 1 is a front view, taken partially in section, illustrating details of an exemplary water heater.

FIG. 2 is a side view, taken partially in section, illustrating details of an exemplary water heater.

FIG. 3 is a front view illustrating details of a lower portion of an exemplary water heater.

FIG. 4 is a diagram illustrating details of an exemplary sealable water heater manifold door.

FIG. 5 is a diagram illustrating details of an exemplary gasket design.

FIG. 6 is a diagram illustrating details of an exemplary assembly device for making a sealable water heater manifold door.

FIG. 7 is a flow chart illustrating an exemplary method of forming a gasket to be adhered to a manifold door base plate to form a sealable water heater manifold door.

FIGS. 8a and 8b illustrate an exemplary method of making a sealable water heater manifold door.

### DETAILED DESCRIPTION

This disclosure relates to efficiently forming gaskets for sealable water heater manifold doors. The disclosure further relates to efficiently and accurately adhering the gaskets to a manifold door base plate to make the sealable water heater manifold door.

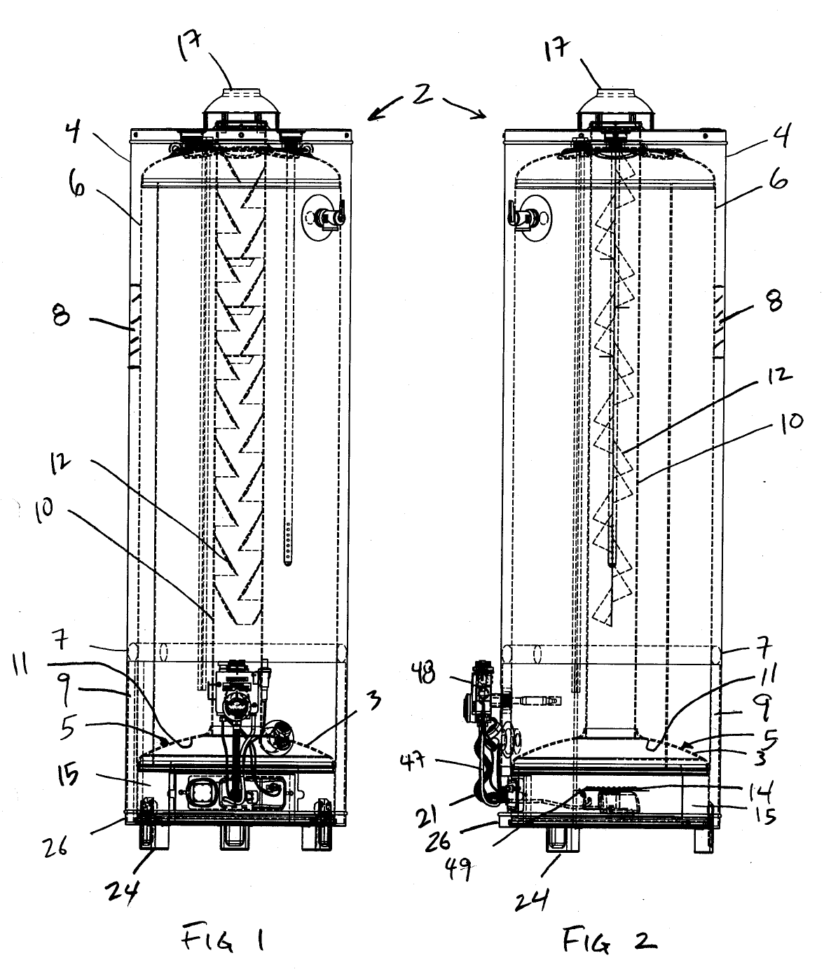

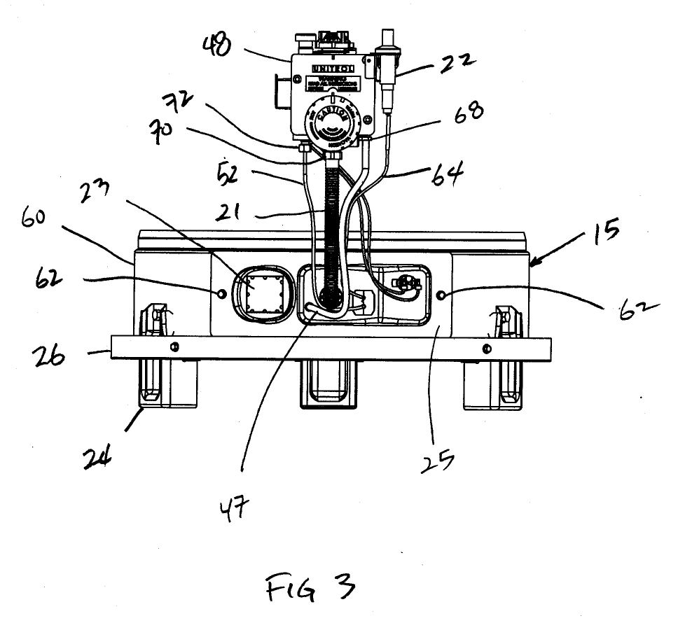

With reference to FIGS. 1 and 2, an exemplary water heater 2 is illustrated. The exemplary water heater 2 is a storage type gas water heater, but this disclosure is not limited to any particular type of water heater.

Water heater 2 includes jacket 4 which surrounds a water tank 6, a main burner 14 in a combustion chamber 15. Passing through the center of the tank 6 is a flue 10, in this instance incorporating a series of baffles 12 to better transfer heat generated by the main burner 14. Water tank 6 is preferably of mains pressure capability and capable of holding heated water. Water tank 6 is preferably insulated by foam insulation 8. Alternative insulation may include fiberglass or other types of fibrous insulation and the like. Fiberglass insulation 9 surrounds combustion chamber 15 and the lowermost portion of water tank 6. It is possible that heat resistant foam insulation can be used if desired. A foam dam 7 separates foamed insulation 8 and fiberglass insulation 9.

Located underneath the water tank 6 is the main burner 14 which uses natural gas or other gases such as LPG, for example. Other suitable fuels may be substituted. Main burner 14 combusts a gas and air mixture and the hot products of combustion resulting rise up through flue 10, possibly with heated air. Water tank 6 is lined with a glass coating for corrosion resistance. Bottom 5 of water tank 6 is preferably coated on both its interior facing surface 3 and exterior facing surface 11. The thickness of the coating of exterior facing surface 11 is about half of the thickness of interior facing surface 3. Also, the lower portion of flue 10 is preferably coated on both of its opposing surfaces. The surface exposed to the flue gases has a thickness about half the thickness of the surface exposed to water in water tank 6. The glass coating helps to prevent scaling of the flue and water tank surfaces.

With reference to FIGS. 1-3, combustion chamber 15 also contains a pilot burner 49 connected to gas control valve 48 by pilot fuel supply line 47. A sheath 52, preferably made of copper, contains wires (not shown) from a flame detecting thermocouple to ensure that in the absence of a flame at pilot burner 49 gas control valve 48 shuts off the gas supply. Thermocouple may be selected from those known in the art. RobertShaw Model No. TS 750U is preferred. Gas control valve 48 supplies fuel to burner 14 by way of fuel supply line 21.

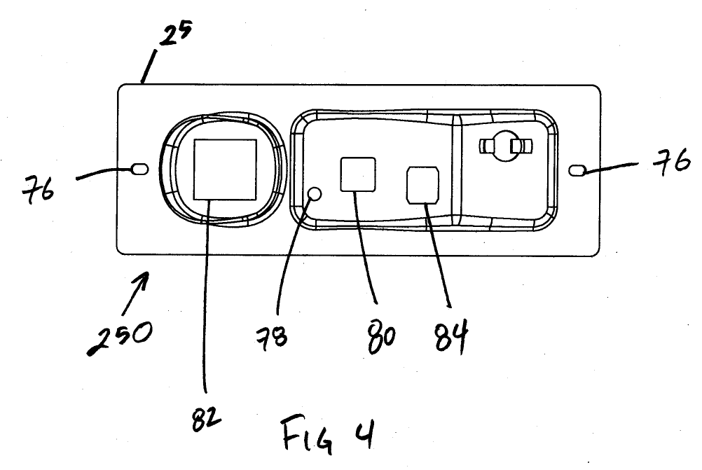

A lower portion of the exemplary water heater 2 is shown. FIG. 3 particularly shows fuel supply line 21 and pilot fuel supply line 47 extending outwardly from a plate 25. Plate 25 is removably sealable to skirt 60 that forms the side wall of combustion chamber 15. Plate 25 is held into position by a pair of screws 62 or by any other suitable means. Pilot fuel supply line 47 and fuel supply line 21 pass through plate 25 in a substantially fixed and sealed condition. Sheath 52 also extends through plate 25 in a substantially fixed and sealed condition as does igniter line 64. Igniter line 64 connects on one end to an igniter button 22 and a piezo igniter. Igniter button 22 can be obtained from Channel Products, for example. Each of pilot fuel supply line 47, fuel supply line 21 and sheath 52 are removably connectable to gas control valve 48 by compression nuts 68, 70 and 72, respectively. Each of compression nut 68, 70 and 72 are threaded and threadingly engage control valve 48.

The products of combustion pass upwards and out the top of jacket 4 via flue outlet 16 after heat has been transferred from the products of combustion. The flue outlet 16 discharges conventionally into a draft diverter 17 which in turn connects to an exhaust duct leading outdoors.

Water heater 2 is preferably mounted on leg 24 to raise bottom pan 26 off the floor. Bottom pan 26 preferably has one or more apertures or some other means (not shown) for receiving combustion air. Where bottom pan 26 meets jacket 4, the mating surfaces (made up from surfaces of bottom pan 26 and jacket 4) can be sealed thoroughly to preventingress of air or any flammable gas or vapor. The cylindrical wall of jacket 4 (the majority of gas water heaters are cylindrical; however, a cubic shaped jacket 4 may be utilized) can be sealed gas tightly so no openings or breaks remain upon assembly and installation.

In particular, gas, water, electrical, control, or other connections, fittings or plumbing, wherever they pass through the jacket 4 or base 26, can be sealed airtight. The joining area of bottom pan 26 to jacket 4 and service entries or exits to the jacket 4 need not be sealed airtight. It is preferred, however, that the space around burner 14 be substantially air/gas tight except for means to supply combustion air.

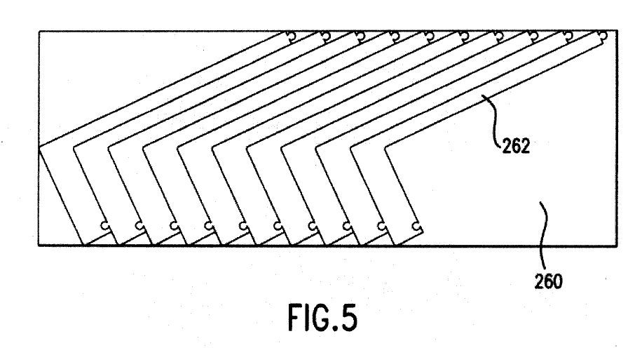

FIG. 4 illustrates an exemplary plate 25 which is sealable water heater manifold door 250. The sealable water heater manifold door 250 includes a gasket (not shown) adhered to an inner surface of base plate 25. The gasket is adapted to be positioned against the outer surface of skirt 60 (see FIG. 3) to ensure that the sealable water heater manifold door 250 is sealed to skirt 60.

The manifold door base plate 25 has a series of openings or holes 76 adapted to receive screws 62 to assist in the mounting and sealing of sealable water heater manifold door 250 against skirt 60. Opening 78 is sized and shaped to closely and sealingly receive pilot fuel supply line 47. Opening 80 is sized and shaped to closely and sealingly receive fuel supply line 21. Opening 82 is sized and shaped to sealingly receive window 23, which preferably snaps into place. Finally, opening 84 is sized and shaped to sealingly receive a plastic connector 86 that contains sheath 52 and igniter line 64.

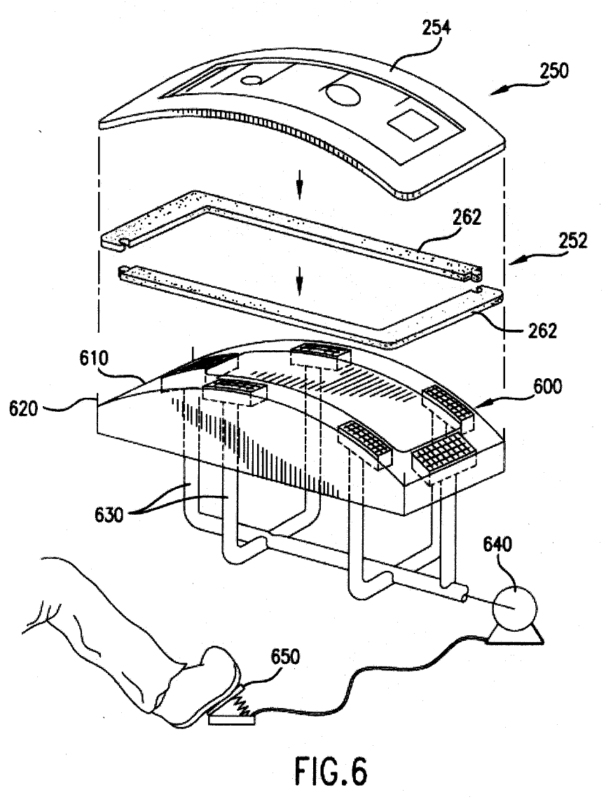

FIG. 5 illustrates an exemplary gasket design used to form the gasket 252 from a sheet or strip of sealing material 260. The sealing material 260 is preferably a silicon sponge having a thickness of about 3/16″. It resists high temperatures and, when cut to form the gasket 252, is adhered to manifold door base plate 254 with an acrylic material. Any number of materials may be used to form the gasket 252 so long as they are heat resistant, can be easily adhered to the door base plate 254, readily form a seal between the door 250 and the surface of the skirt 60 and may be cut with relative ease and precision.

The sealing material 260 may be cut to form a multiplicity of substantially identical partial gaskets 262 which are most preferably half gaskets. Each half gasket 262 has opposed ends that are adapted to engage opposed ends of another half gasket 262. When engaged, opposed ends of two half gaskets 262 form a gasket 252 with an opening 86 that is sized essentially the same as a corresponding opening in the skirt 60 of the combustion chamber. The opposed ends of a half gasket 262 may comprise a tab and slot that engage a corresponding slot and tab of another half gasket 262. The connection of the tab and slot forms a seal that, when adhered to the manifold door base plate 254 and sealed to skirt 60, prevent air leakage from the water heater 2. The tab and slot may be of numerous geometrical shapes, such as, but not limited to, triangular, circular, quadrilateral or the like.

The half gaskets 262 are arranged on the sealing material 260 to minimize waste of sealing material 260. Each half gasket 262, shaped in the form of the letter “L”, is nested within another half gasket 262 to align the vertical and horizontal portions of each L-shaped half gasket 262. In this manner, there is little or no excess sealing material 260 between each nested half gasket 262. Additionally, only a small amount of wasted sealing material 260 remains at the top and bottom edges of the material 260. The half gasket shape, as well as the nesting arrangement, allows for the sealing material 260 to form multiple gaskets 252 as opposed to the traditional manner in which a one-piece gasket is cut from the sealing material 260. In the traditional cutting process, waste material of up to 20 square inches per gasket 252 results. With the half gasket nesting arrangement, the wasted amount of sealing material 260 per gasket 252 is reduced to approximately 1.64 square inches.

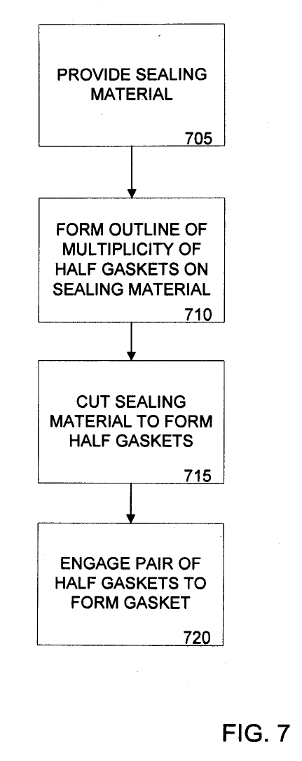

With reference to FIG. 6, an exemplary assembly device 600 used for making a sealable water heater manifold door 250 is shown. The assembly device 600 assists in easy and accurate adherence of the gasket 252 to the manifold door base plate 254.

The assembly device 600 includes an upper surface 610 adaptable to receive the half gaskets 262 as well as the manifold door base plate 254 for placement thereon. The contour of the upper surface 610 is preferably curved to match the contour of the manifold door base plate 254. Additionally, the upper surface 610 may include manifold door guides 620 to assist in accurately placing the half gaskets 262 and the manifold door base plate 254 on the assembly device 600. The outer edges of the half gaskets 262 and the manifold door base plate 254 may, for example, be placed in contact with the manifold door guides 620, which may be positioned along the perimeter of the upper surface 610.

The assembly device 600 further includes one or more vacuum channels 630 connected to a vacuum pump 640, operated by a operator switch 650 which may be, for example, a foot pedal. When placed on the upper surface 610 of the assembly device 600, the bottom face of the gasket 252 is aligned with the vacuum channels 630. Upon activation of the operator switch 650, the vacuum pump 640 supplies negative pressure to the vacuum channels 630, thereby causing the gasket 252 to be held in its applied position. With the gasket 252 securely held in place, the gasket 252 may be accurately adhered to the manifold door base plate 254. Although FIG. 6 depicts a vacuum system, it is possible to employ other assembly devices that guide and retain the gaskets 252 in selected positions. Representative examples include light adhesives, static electricity, additional guides or the like.

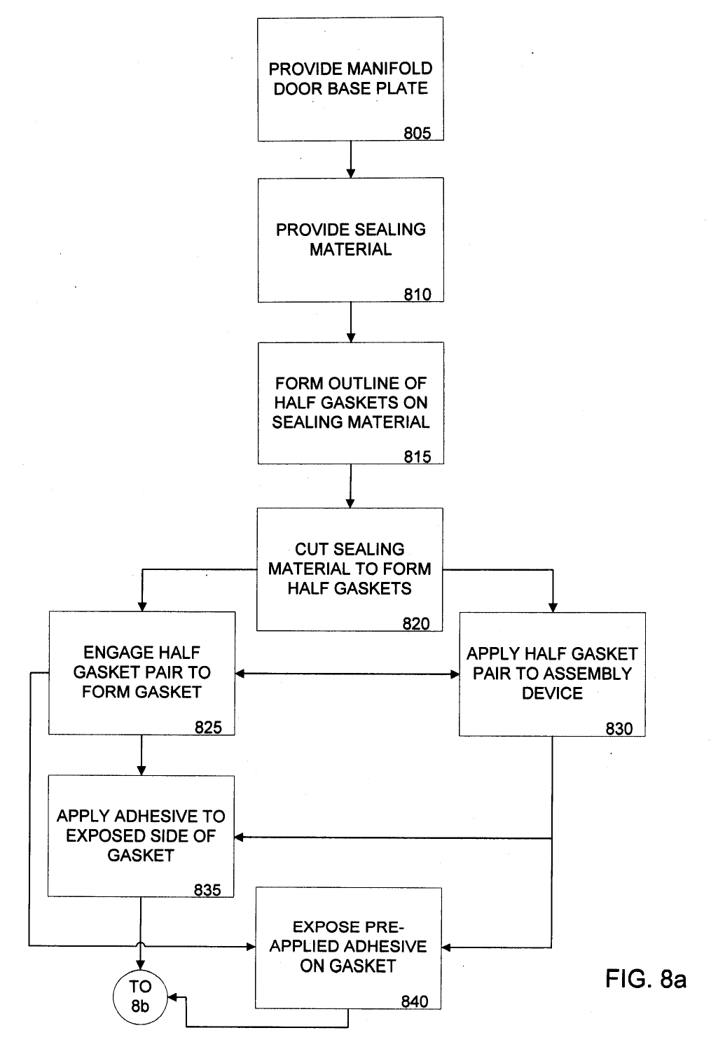

FIG. 7 is a flow chart illustrating an exemplary method of forming a gasket 252 to be adhered to a manifold door base plate 254 for forming a sealable water heater manifold door 250.

At 705, a sheet or strip of sealing material 260 is provided. The sealing material 260 is a heat resistant material and may be foam insulation, a composite material, or fiberglass reinforced silicone sponge, for example.

At 710, an outline of a multiplicity of half gaskets 262 is formed on the sealing material 260. The outline of the multiplicity of half gaskets 262 is arranged in such a way as to minimize sealing material 260 that is wasted or unusable after the material 260 is cut to create the gaskets 252. Each of the multiplicity of half gaskets 262 has an L-shape, and each of the half gaskets 262 is arranged in a nesting configuration on the sealing material 260 to align the vertical portions and the horizontal portions of the L-shaped half gaskets 262. Additionally, each of the L-shaped half gaskets 262 are positioned at an angle relative to the top and bottom edges of the sealing material 260 to maximize the number of half gaskets 262 configured on the sealing material 260.

At 715, the sealing material 260 is cut along the outline of the multiplicity of half gaskets 262.

At 720, a pair of half gaskets 262 are engaged at their opposed ends to form a gasket 252. Each half gasket 262 has opposed ends adapted to engage opposed ends of another half gasket 262. The opposed ends may be a tab and a slot adapted to engage a corresponding slot and tab of another half gasket 262. The tab and slot may be of various geometrical configurations, such as triangular, circular, quadrilateral or the like in shape.

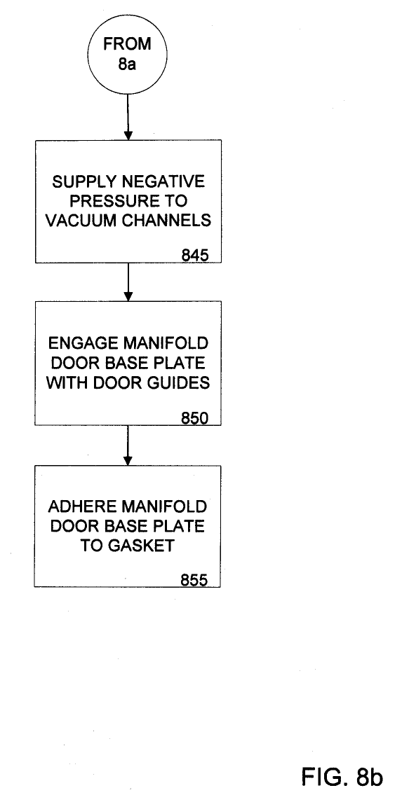

FIGS. 8a and 8b illustrate an exemplary method of making a sealable water heater manifold door 250.

At 805, a manifold door base plate 254 is provided. The manifold door base plate 254 is sized and shaped to cover an opening in a water heater combustion chamber, such as a combustion chamber 15 of the exemplary water heater 2 described above with relation to FIGS. 1-3.

At 810, a sheet or strip of sealing material 260 is provided. The sealing material 260 is a heat resistant material such as a foam insulation, a composite material, or a fiberglass reinforced silicone sponge.

Optionally, at 815, an outline of multiple half gaskets 262 is formed on the sealing material 260.

At 820, following 810 or 815, the sealing material 260 is cut to form multiple half gaskets 262. If, at 815, an outline is formed on the sealing material 260, then the cutting process at 820 includes cutting the sealing material along the outline of half gaskets 262. The half gaskets 262 are necessary for adherence to the manifold door base plate 254 and are substantially identical.

The half gaskets 262 are shaped substantially as an “L,” and the half gaskets 262 may be configured in a nesting arrangement on the sealing material 260, where the half gaskets 262 are nested within one another to align the horizontal and vertical portions of each “L” half gasket 262. The arrangement minimizes loss of sealing material 260 as scrap.

Each half gasket 262 includes opposed ends adaptable to engage opposed ends of another half gasket 262. The opposed ends may include a tab and a slot adapted to engage a corresponding slot and tab of another half gasket 262. In other words, the opposed ends have complementary shapes. The tabs and slots may be substantially round as shown in FIG. 5, for example, or may be any other shape such as triangular.

At 825, a pair of half gaskets are engaged at their opposed ends to form a gasket 252.

At 830, a pair of half gaskets 262 are applied to an assembly device, such as the exemplary assembly device 600 described with relation to FIG. 6. The pair of half gaskets 262 are applied in a selected position relative to a manifold door guide, such as the door guides 620 of the assembly device 600, that is used to assist in accurate placement and alignment of the half gaskets 262.

The engagement of the half gaskets 262 may occur prior to applying the half gaskets 262 to the assembly device 600. Alternatively, the half gaskets 262 may be engaged at 825 after applied in the selected position to the assembly device 600.

Optionally, at 835, following either 825 or 830, an adhesive is applied to the exposed side of the gasket 252. Alternatively, at 840, a pre-applied adhesive may be exposed. For example, a removable material may cover and protect the pre-applied adhesive, and the pre-applied adhesive may be exposed by removing the protective material. The adhesive may be, for example, an acrylic material such as a glue substance.

Optionally, at 845, negative pressure is supplied to vacuum channels 630 of the assembly device 600 to hold in place the gasket 252. The vacuum channels 630 are aligned with a bottom face of the gasket 252. The negative pressure may be supplied before or after the adhesive is applied to the gasket at 835 or the adhesive is exposed at 840.

At 850, the manifold door base plate 254 is engaged with the manifold door guides 620 for alignment with the gasket 252.

At 855, the manifold door base plate 254 is adhered to the gasket 252 to form the sealable water heater manifold door 250. The adherence of the manifold door base plate 254 to the gasket 252 may be by simply pressing the manifold door base plate to the exposed side of the gasket 252 containing the adhesive.

Although specific structures and steps have been shown and described herein for purposes of illustration and exemplification, it is understood by those of ordinary skill in the art that the specific structures and steps shown and described may be substituted for a wide variety of alternative and/or equivalent implementations without departing from the scope of the appended claims. This disclosure is intended to cover any adaptations or variations of the structures and steps discussed herein.

What is claimed:

1. A method of making a sealable water heater manifold door, the method comprising:
providing a door base plate sized and shaped to cover an opening in a water heater combustion chamber;
providing a sheet or strip of sealing material;
cutting the sealing material to form a multiplicity of partial gaskets, wherein each partial gasket has opposed ends adapted to engage opposed ends of another partial gasket;
applying a pair of partial gaskets to an assembly device in a selected position relative to a door guide, wherein the pair of partial gaskets are engaged at their opposed ends to form a gasket;
engaging the door base plate with the door guide to align the door base plate with the gasket; and
adhering the door base plate to the gasket to form the sealable water heater manifold door.

2. The method of claim 1, wherein the partial gaskets are substantially identical.

3. The method of claim 1, further comprising:
forming an outline of each of the multiplicity of partial gaskets on the sealing material, wherein the outline of each of the multiplicity of partial gaskets are nested within one another; and
wherein cutting the sealing material to form a multiplicity of partial gaskets comprises cutting the sealing material along the outline of each of the multiplicity of partial gaskets.

4. The method of claim 1, wherein each of the multiplicity of partial gaskets comprise an L-shape; wherein the outline of each of the multiplicity of partial gaskets are nested within one another so that the vertical portions of the L-shaped partial gaskets are aligned and the horizontal portions of the L-shaped partial gaskets are aligned on the sealing material; and wherein the multiplicity of partial gaskets are arranged on the sealing material to minimize loss of sealing material.

5. The method of claim 1, wherein the pair of partial gaskets are engaged at their opposed ends to form a gasket (i) prior to applying the pair of partial gaskets to the assembly device or (ii) after the pair of partial gaskets are applied to the assembly device.

6. The method of claim 1, further comprising applying an adhesive to an exposed side of the gasket.

7. The method of claim 1, further comprising exposing an adhesive pre-applied to an exposed side of the gasket.

8. The method of claim 6, wherein adhering the door base plate to the gasket comprises pressing the door base plate to the exposed side of the gasket with the adhesive.

9. The method of claim 6, wherein the adhesive comprises an acrylic material.

10. The method of claim 1, wherein the opposed ends of each partial gasket are different from each other but are complements of each other such that one opposed end on one partial gasket can lock on to a complementary opposed end of another partial gasket.

11. The method of claim 1, wherein the opposed ends of a partial gasket comprise a tab and a slot adapted to engage a corresponding slot and tab of another partial gasket.

12. The method of claim 1, further comprising supplying negative pressure to vacuum channels of the assembly device to hold in place the gasket applied in the selected position, wherein the vacuum channels are aligned with a face of the gasket.

13. A method of forming a gasket to be adhered to a manifold door base plate to form a sealable water heater manifold door, the method comprising:
providing a sheet or strip of sealing material;
forming an outline of a multiplicity of partial gaskets on the sealing material, wherein each partial gasket has opposed ends adapted to engage opposed ends of another partial gasket, wherein the outline of the multiplicity of partial gaskets is arranged on the sealing material to minimize excess sealing material;
cutting the sealing material along the outline of the multiplicity of partial gaskets to form the multiplicity of partial gaskets; and
engaging a pair of partial gaskets at their opposed ends to form the gasket.

14. The method of claim 13, wherein each of the multiplicity of partial gaskets has an L-shape, and wherein the multiplicity of partial gaskets are arranged in a nesting configuration on the sealing material so that the vertical portions of the L-shaped partial gaskets are aligned and the horizontal portions of the L-shaped partial gaskets are aligned.

15. The method of claim 14, wherein the multiplicity of partial gaskets are configured on the sealing material so that each of the multiplicity of L-shaped partial gaskets are positioned at an angle on the sealing material to maximize the number of L-shaped partial gaskets on the sealing material.

16. The method of claim 13, wherein the opposed ends of a partial gasket comprise a tab and a slot adapted to engage a corresponding slot and tab of another partial gasket.

17. The method of claim 16, wherein the tab and slot are one of (i) triangular; (ii) circular; or (iii) quadrilateral in shape.

18. The method of claim 13, wherein the sealing material is heat resistant.

19. The method of claim 13, wherein the sealing material is one of (i) foam insulation; (ii) a composite material; or (iii) silicon sponge.

20. The method of claim 13, wherein the opposed ends of each partial gasket are different from each other but are complements of each other such that one opposed end on one partial gasket can lock on to a complementary opposed end of another partial gasket.
